(19) United States
(12) Patent Application Publication
(10) Pub. No.: US 2010/0270882 A1
(43) Pub. Date: Oct. 28, 2010

(54) Generator-Powered Electric Motor Circuit

(76) Inventor: Jorge Luis Caro, Lawrenceville, GA (US)

Correspondence Address: Anthony T. Whittington, 2312 3rd Ave. Unit 722, Seattle, WA, 98121, US

(21) Appl. No.: 12/486,659

(22) Filed: Jun. 17, 2009

Related U.S. Application Data
(60) Provisional application No. 61/171,901, filed on Apr. 23, 2009.

(51) Int. Cl. H02K 47/14; H02K 53/00

(52) U.S. Cl. 310/113; 415/916

(57) ABSTRACT

A generator powered electric circuit is provided. The generator powered electric motor circuit includes a motor; a controller that monitors the power cycle corresponding to the motor; a fuel cell that initiates a power-up cycle corresponding to the motor; and a generator that is coupled to the motor.

### CROSS-REFERENCES TO RELATED APPLICATIONS

The present application claims the benefit of U.S. Provisional Application No. 61/171,901, entitled “GENERATOR-POWERED ELECTRIC MOTOR CIRCUIT,” filed on Apr. 23, 2009, which is hereby incorporated by reference herein in its entirety.

### FIELD OF THE TECHNOLOGY

The present disclosure generally relates to reusable energy sources and, more specifically, to rechargeable battery cells.

### DESCRIPTION OF THE RELATED ART

Energy sources are a vital part of our everyday lives. For example, U.S. consumers who drive vehicles use about 390 million gallons of gasoline a day. Given that there is limited supply of gasoline sources, many efforts have been made to explore alternate fuel sources and improve energy conservation. As such, it would be desirable to provide an apparatus that recharges fuel cells using any form of energy.

### SUMMARY

In one aspect, an apparatus for recharging fuel cells is provided. The apparatus includes a motor; a controller to monitor the power cycle corresponding to the motor; a fuel cell that initiates a power-up cycle corresponding to the motor; and a generator that is coupled to the motor.

In another aspect, an electro-mechanical system for recharging fuel cells is provided. The electro-mechanical system includes a controller; a motor; a fuel cell that initiates a power-up cycle corresponding to the motor; a power inverter; and a generator that is coupled to the motor, wherein the controller is configured to monitor the power cycle between the generator and motor.

In still another aspect, a method for recharging fuel cells is provided. The method includes: generating an input signal by an ignition circuit; receiving an input signal by a controller from a fuel cell circuit to determine the energy level of the fuel cell; transmitting the input signal to the motor to initiate the power up cycle of the motor; initiating the generator to begin a power up cycle; and converting the mechanical energy produced by the motor into electrical energy corresponding to the generator such that the electrical energy that comes from the fuel cell powers the motor and the generator to create a continuous cycle of energy.

In yet another aspect, a means for recharging fuel cells is provided. The means includes: a means for generating an input signal; a means for determining the energy level of the fuel cell; means for initiating the power up cycle of a motor; means for initiating the power up cycle of a generator; and means for converting the mechanical energy produced by the motor into electrical energy corresponding to the generator.

In still another aspect, a computer-readable medium having computer executable instructions for implementing a method for recharging fuel cells is provided. The computer-readable medium has computer executable instructions that include: generating an input signal by an ignition circuit; receiving an input signal by a controller from a fuel cell circuit to determine the energy level of the fuel cell; transmitting the input signal to the motor to initiate the power up cycle of the motor; initiating the generator to begin a power up cycle; and converting the mechanical energy produced by the motor into electrical energy corresponding to the generator such that the electrical energy that comes from the fuel cell powers the motor and the generator to create a continuous cycle of energy.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

These and other features, aspects and advantages of the present invention will become better understood with reference to the following drawings, description and claims.

### BRIEF DESCRIPTION OF THE DRAWINGS

The present invention is described in detail below with reference to the attached drawing figures, which are incorporated by reference herein and wherein:

FIG. 1 is block diagram in accordance with an exemplary embodiment of the invention;

FIG. 2 is a schematic diagram in accordance with an exemplary embodiment of the invention;

FIG. 3 is a schematic diagram in accordance with another exemplary embodiment of the invention; and

FIG. 4 is a flowchart in accordance with another exemplary embodiment of the invention.

### DETAILED DESCRIPTIONS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

Broadly, an embodiment of the present invention generally provides a generator powered electric motor circuit having a controller; a motor; a fuel cell that initiates a power-up cycle corresponding to the motor; and a generator that is coupled to the motor.

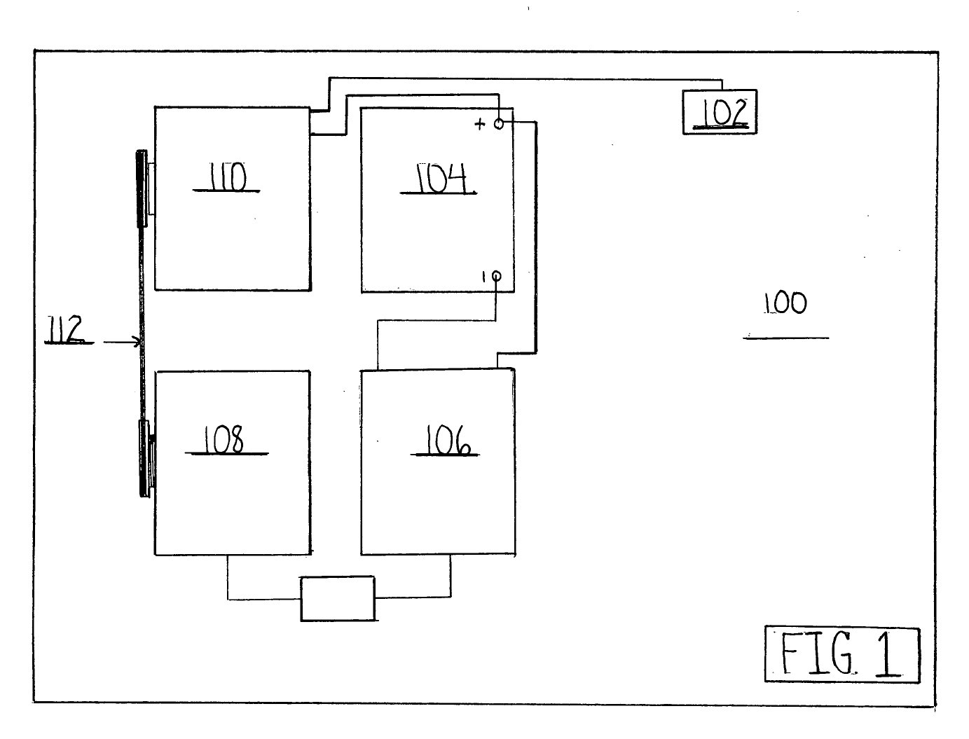

Embodiments of the present invention are discussed in connection with the following figures: FIGS. 1, 2, 3 and 4.

FIG. 1 shows a block diagram of a generator powered electric motor circuit. As shown in FIG. 1, the generator powered electric motor circuit 100 may include a controller 102 (shown as a switch), a fuel cell circuit 104 (shown as a 12V battery), a power inverter 106, a motor 108, and a generator 110. The motor 108 may be powered in the following manner. For example, the controller 102 receives a current input signal from the fuel cell circuit 104 initiated by an ignition circuit (not shown). Thereafter, the controller 102 passes the signal to the motor 108 to begin its power up cycle.

The motor 108 is coupled to the generator 110 via a belt 112. As such, when the motor 108 begins to power up, the generator 110 begins to power up as well. Once the motor 108 begins to rotate at predetermined rotary speed, the generator 110 reaches its predetermined rotary speed and begins to convert the mechanical energy produced by the rotating motor 108 to electrical energy to power the electrical motor circuit. As a result, the energy generated by the electrical circuit may be used to recharge the fuel cell circuit 104. Alternatively, the energy generated may be used to power the motor 108.

In one exemplary embodiment, the controller 102 may be a processor. A processor includes any electrical circuit capable of executing computer programs or instructions. The controller 102 may be configured to monitor and control the power up and power down cycle of the generator powered electric circuit. For example, the controller 102 may configured to monitor the power cycle between the generator 110 and motor 108.

In another exemplary embodiment, the fuel cell circuit 104 may include one or more cells of energy such as a battery, power supply, etc. Additionally, the storage capacity of the fuel cell 104 may include 6 V, 12V, 24V, etc. or any voltage capacity desired by one of ordinary skill in the art. The fuel cell 104 may also be configured to initiate a power-up cycle corresponding to the motor by sending a current input signal via the controller 102. Alternatively, one of ordinary skill in the art could use an ignition circuit (not shown) to initiate a power-up cycle corresponding to the motor 108.

In still another embodiment, the power inverter 106 is used to convert the voltage level for different voltage sources. The power inverter 106 includes any inverter that converts the direct current (DC) electricity from sources such as batteries, solar panels, or fuel cells to alternating current (AC) electricity. The electricity can be at any required voltage; in particular it can operate AC equipment designed for mains operation, or rectified to produce DC at any desired voltage.

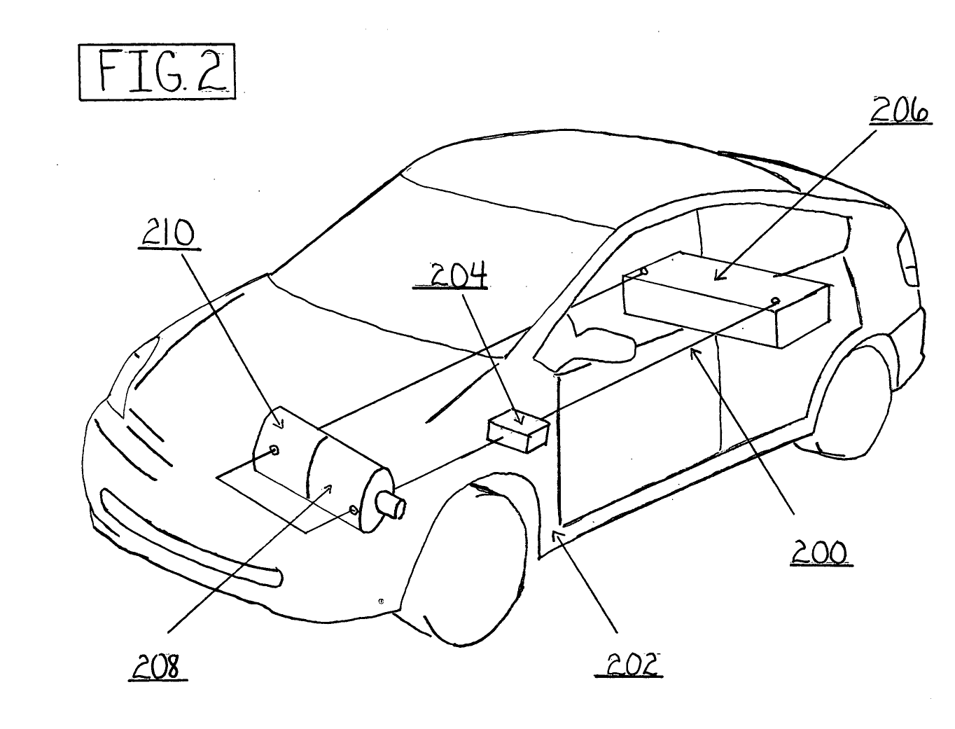

FIG. 2 shows a schematic diagram in accordance with an exemplary vehicle embodiment of the invention. As shown FIG. 2, the generator powered electric motor circuit 202 may used to power a vehicle. As discussed earlier (with regard to FIG. 1), the generator powered electric motor circuit 202 may include a controller 204, a fuel cell circuit 206 (shown as a battery pack), a motor 208, and a generator 210. Similarly, the motor 208 may be powered in the manner described above in connection to FIG. 1.

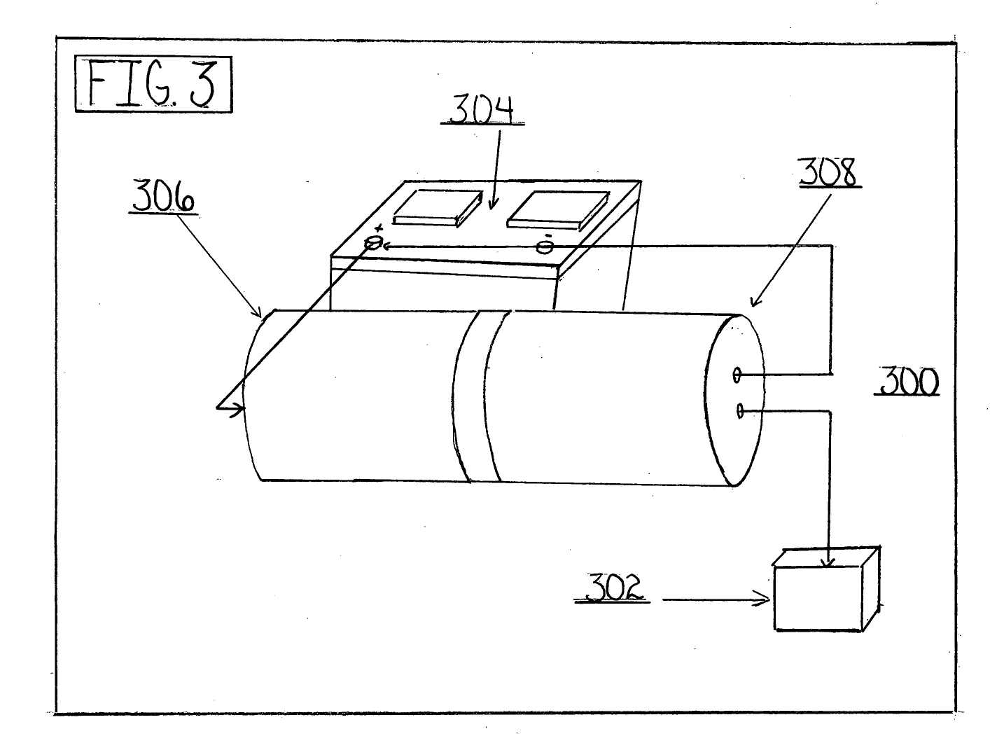

FIG. 3 shows a schematic diagram in accordance with an exemplary house generator embodiment of the invention. As shown FIG. 3, the generator powered electric motor circuit 300 may used to power a home (not shown). As discussed earlier (with regard to FIG. 1 and FIG. 2), the generator powered electric motor circuit 300 may include a controller (not shown), a fuel cell circuit 302 (shown as a battery), a motor 304 (shown as an electric motor), and a generator 306. Similarly, the motor 304 may be powered in the manner described above in connection to FIG. 1.

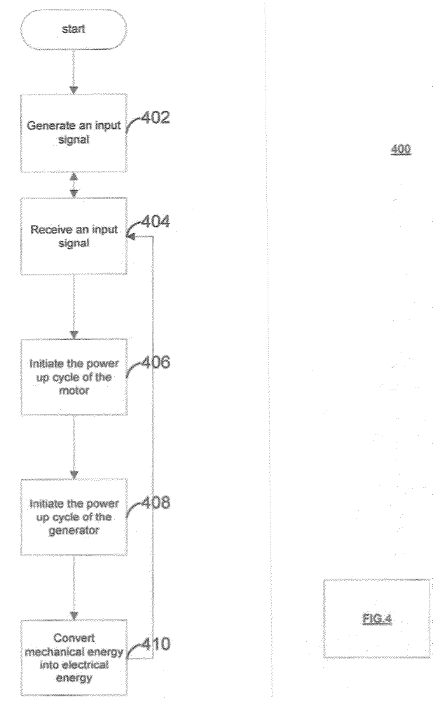

FIG. 4 shows a flowchart describing a process 400 in accordance with an exemplary embodiment of the invention (with regard to FIG. 1). At block 402, an input signal may be generated by an ignition circuit (not shown). At block 404, an input signal may be received by the controller 102 from the fuel cell circuit 104. The input signal may be used to determine the energy level of the fuel cell. At block 406, the controller 102 may transmit the input signal to the motor 108 to initiate its power up cycle. At the same time, the generator may be initiated to begin its power up cycle (block 408). At block 410, the generator 110 may convert mechanical energy produced by the motor 108 into electrical energy corresponding to the generator. As a result, the fuel energy that comes from the fuel cell powers the motor and the generator to create a continuous cycle of energy.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

What is claimed is:

1. An apparatus for recharging fuel cells, comprising:
a motor;
a controller to monitor the power cycle corresponding to the motor;
a fuel cell that initiates a power-up cycle corresponding to the motor; and
a generator that is coupled to the motor.

2. The apparatus of claim 1, wherein the motor is an electric motor.

3. The apparatus of claim 1, wherein the controller is a processor.

4. The apparatus of claim 1, further comprising: a power inverter to convert the voltage level for different voltage sources.

5. The apparatus of claim 1, further comprising: an ignition switch to generate an input signal for starting the power up cycle of the motor and generator.

6. An electro-mechanical system for recharging fuel cells, comprising:
a motor;
a controller to monitor the power cycle corresponding to the motor;
a fuel cell that initiates a power-up cycle corresponding to the motor;
a power inverter to convert the voltage level for different voltage sources; and
a generator that is coupled to the motor.

7. The electro-mechanical system of claim 6, wherein the motor is an electric motor.

8. The electro-mechanical system of claim 6, wherein the controller is a processor.

9. The electro-mechanical system of claim 6, further comprising: an ignition switch to generate an input signal for starting the power up cycle of the motor and generator.

10. The electro-mechanical system of claim 6, wherein the controller is configured to monitor the power cycle between the generator and motor.

11. A method for recharging fuel cells, the method comprising:
generating an input signal by an ignition circuit;
receiving an input signal by a controller from a fuel cell to determine the energy level of the fuel cell;
transmitting the input signal to the motor to initiate the power up cycle of the motor;
initiating the generator to begin a power up cycle; and
converting the mechanical energy produced by the motor into electrical energy corresponding to the generator such that the electrical energy that comes from the fuel cell powers the motor and the generator to create a continuous cycle of energy.

12. The method according to claim 11, wherein the motor is an electric motor.

13. The method according to claim 11, wherein the controller is a processor.

14. The method according to claim 11, further comprising: converting one or more voltage levels for different voltage sources.

15. The apparatus of claim 1, wherein the fuel cell is a battery.

16. The electro-mechanical system of claim 6, wherein the fuel cell is a battery.

17. The method according to claim 11, wherein the fuel cell is a battery.

18. The apparatus of claim 1, further comprising: a belt that couples the motor to the generator.

19. The electro-mechanical system of claim 6, further comprising: a belt that couples the motor to the generator.

20. The method according to claim 11, further comprising: monitoring the power up cycle of the motor and the generator.
